(19) United States
(12) Patent Application Publication
(10) Pub. No.: US 2006/0194609 A1
(43) Pub. Date: Aug. 31, 2006

(54) Wireless communication apparatus and communicating method thereof

(75) Inventor: Hideyuki Matsuo, Fukuoka-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/331,271

(22) Filed: Jan. 13, 2006

(30) Foreign Application Priority Data
Jan. 17, 2005 (JP) 2005-008809

(51) Int. Cl. H04M 1/00

(52) U.S. Cl. 455/552.1; 455/426.1

(57) ABSTRACT

In a wireless communication apparatus 1 for executing transmission and reception of a voice signal using a wireless communication technique, composed of a sub station 3 and a base station 2 which executes wireless communication with a mobile terminal in either operation mode of a master mode and a slave mode, wherein the base station 2 includes a wireless communicating unit 6 for executing duplex voice communication with the sub station 3 and mobile terminal 4, a master-slave changing unit 14 for changing either operation mode of the master mode and the slave mode according to whether or not the mobile terminal 4 has a master-slave changing function, and a registered information storage unit 11 for storing registered information of the sub station 3 and the mobile terminal 4, thereby permitting plural wireless communication terminals serving as slaves.

### BACKGROUND OF THE INVENTION

This invention relates to a wireless communication apparatus for executing transmission and reception of a voice signal using a wireless communication technique, and also capable of changing either operation mode of a master mode and a slave mode for a mobile terminal, thereby permitting communication with plural devices serving as slaves.

Conventionally, the wireless communication apparatus relied on Bluetooth communication standard permits communication by changing the operation mode between the master mode and the slave mode through a predetermined key operation.

FIG. 5 is a block diagram of a conventional wireless communication apparatus.

Referring to FIG. 5, in a mobile telephone 51, a CPU 57 (control means) is connected to a telephone communication unit 58 for executing the communication processing relative to telephone communication; a voice processing unit 56 for executing the voice processing (encoding processing, decoding processing, etc.) of transmitted voice received by a microphone 52 and received voice transmitted by a speaker 53; a key pad 54 (operating means) on which a large number of keys inclusive of a talk key for starting talk, an end key for ending the talk and numeral keys of 0 to 9 for inputting a telephone number are arranged; a display 55 (informing means) for displaying the telephone number of an originator; and a memory 60 for storing memory dial information and others.

Further, the CPU 57 is also connected to a Bluetooth communication unit 59 (communication means) for executing the communication processing relative to the communication relied on the Bluetooth communication standard for a handsfree device 61 described later.

Incidentally, it should be noted that the mobile telephone 51 is driven by the power supplied from the secondary battery (not shown) such as a lithium battery.

The handsfree device 61 is loaded within the passenger room of a vehicle. In the handsfree device 61, a CPU 63 (control (control means) is connected to a voice processing unit 64 for executing the voice processing (encoding processing, decoding processing, etc.) of transmitted voice received by a microphone 65 and received voice transmitted by a speaker 66; an operating switch 67 on which keys inclusive of a talk key for starting talk, an end key for ending the talk and a hold key for holding the talk.

Further, the CPU 63 is also connected to a Bluetooth communication unit 62 (communication means) for executing the communication processing relative to the communication relied on the Bluetooth communication standard for the mobile telephone 51 described above.

Incidentally, it should be noted that the handsfree device 61 is driven by the power supplied from a battery (not shown) loaded within the vehicle (e.g. JP-A-2002-101166).

Next, an explanation will be given of the operation of the conventional wireless communication apparatus as described above. In the communication relied on the Bluetooth communication standard, there are concepts of “master” and “slave”. In view of this, the Bluetooth communication unit 59 of the mobile telephone 51 and the Bluetooth communication unit 62 of the handsfree device 61 can execute the communication with other communication devices in either operation mode of communication modes of a master mode serving as a master device for the other communication device and a slave mode serving as a slave device for the other communication device. In this case, if connection (establishment of a communication line) is attempted for the other Bluetooth communication unit, communication is done in the operation mode of the master mode; and if the connection is attempted from the other Bluetooth communication unit, the communication is done in the operation mode of the slave mode.

Therefore, in such a case, on the assumption of a common manner of using, a user brings the mobile telephone 51 into the vehicle room and attempts connection to the handsfree device 61 by a predetermined key operation for the key pad 54. Thus, the mobile telephone 51 having attempted the connection to the handsfree device 61 serves as the master device whereas the handsfree device 61 for which connection is attempted from the mobile telephone 51 serves as the slave device.

And in the mobile telephone 51, the CPU 57 can issue a change command to the Bluetooth communication unit 59 to change the operation mode of the Bluetooth communication unit 59. Namely, while the mobile telephone 51 is in the operation mode of the master mode, by issuing the change command to the Bluetooth communication unit 59, the mobile telephone 51 can change its operation mode from the master mode to the slave mode. On the other hand, while the mobile telephone 51 is in the operation mode of the slave mode, by issuing the change command to the Bluetooth communication unit 59, the mobile telephone 51 can change its operation mode from the slave mode to the master mode.

Likewise, in the handsfree device 61, the CPU 63 can issue a change command to the Bluetooth communication unit 62 to change the operation mode of the Bluetooth communication unit 62. Namely, while the handsfree device 61 is in the operation mode of the master mode, by issuing the change command to the Bluetooth communication unit 62, the handsfree device 61 can change its operation mode from the master mode to the slave mode. On the other hand, while the handsfree device 61 is in the operation mode of the slave mode, by issuing the change command to the Bluetooth communication unit 62, the handsfree device 62 can change its operation mode from the slave mode to the master mode.

The wireless communication apparatus described above was constructed so that the operation mode is changed on condition that a predetermined key is operated in the mobile telephone 51. However, the operation mode can be also changed on condition that a predetermined key is operated in the handsfree device 61. Further, by using e.g. a timer function, the operation mode can be also automatically changed on condition that a predetermined timing or predetermined timing can be timed.

However, in the wireless communication apparatus described above, the operation mode can be changed between the master mode and the slave mode by the predetermined key operation by the user, or otherwise can be automatically changed using the timer function. However, there were troublesomeness of requiring the key operation by the user or a problem of permitting the change to be made through the automatic change only on condition that the predetermined timing or time has been timed and not permitting the change to be made until the predetermined timing or time is timed.

### SUMMARY OF THE INVENTION

This invention has been accomplished in order to solve the above problem. An object of this invention is to provide a wireless communication apparatus in which loading of a master-slave changing unit permits master-slave change to be automatically made regardless of whether or not a mobile terminal has a master-slave changing function so that a base station can operate in the master mode for a sub station or the mobile terminal, thereby making wireless communication with plural wireless terminals serving as slaves, and a method for controlling the wireless communication apparatus.

In order to attain the above object, in accordance with this invention, there is provided a wireless communication apparatus for executing transmission and reception of a voice signal using a wireless communication technique, composed of a sub station and a base station which executes wireless communication with a mobile terminal in either operation mode of a master mode and a slave mode, comprising a master-slave changing unit capable of automatically making the master-slave change regardless of whether or not the mobile terminal has a master-slave changing function.

In accordance with this configuration, the base station can operate in a master mode for the sub station and mobile terminal, thereby permitting plural wireless communication terminals serving as slaves.

As described above, in accordance with this invention, there is provided a wireless communication apparatus for executing transmission and reception of a voice signal using a wireless communication technique, composed of a sub station and a base station which executes wireless communication with a mobile terminal in either operation mode of a master mode and a slave mode, wherein the base station includes a wireless communicating unit for executing duplex voice communication with the sub station and mobile terminal, a master-slave changing unit for changing either operation mode of the master mode and the slave mode in the wireless communication with the mobile terminal according to whether or not the mobile terminal has a master-slave changing function, and a registered information storage unit for storing registered information of the sub station and the mobile terminal so that the base station can operate in the master mode for the sub station and the mobile terminal, thereby providing an advantage of permitting plural wireless communication terminals serving as slaves.

In accordance with this invention, there is provided a wireless communication apparatus for executing transmission and reception of a voice signal using a wireless communication technique, composed of a sub station and a base station which executes wireless communication with a mobile terminal in either operation mode of a master mode and a slave mode, wherein the base station includes a wireless communicating unit for executing duplex voice communication with the sub station and mobile terminal, a master-slave changing unit for changing either operation mode of the master mode and the slave mode in the wireless communication with the mobile terminal according to whether or not the mobile terminal has a master-slave changing function, and a registered information storage unit for storing registered information of the sub station and the mobile terminal so that the base station can operate in the master mode for the sub station and the mobile terminal.

In accordance with this configuration, the master slave change can be automatically made regardless of whether or not the mobile terminal has the master slave changing function and the base station can operate in the master mode for the sub station and the mobile terminal, thereby providing an advantage of permitting plural wireless communication terminals serving as slaves.

The wireless communication apparatus may include plural sub stations.

Thus, the base station can operate in the master mode for plural sub stations and mobile terminals, thereby providing an advantage of permitting plural wireless communication terminals serving as slaves.

The method for controlling a wireless communication apparatus according to this invention for executing transmission and reception of a voice signal using a wireless communication technique, composed of a sub station and a base station which executes wireless communication with a mobile terminal in either operation mode of a master mode and a slave mode, wherein the base station executes a wireless communicating step of executing duplex voice communication with the sub station and mobile terminal, a master-slave changing step of changing either operation mode of the master mode and the slave mode in the wireless communication with the mobile terminal according to whether or not the mobile terminal has a master-slave changing function, and a registered information storage step of storing registered information of the sub station and the mobile terminal.

In accordance with this configuration, the master-slave change can be automatically made regardless of whether or not the mobile terminal has the master-slave changing function and the base station can operate in the master mode for the sub station and the mobile terminal, thereby providing an advantage of permitting plural wireless communication terminals serving as slaves.

### BRIEF DESCRIPTION OF THE DRAWINGS

FIG. 1 is a block diagram of a wireless communication apparatus according to the first embodiment of this invention.

FIG. 2 is a flowchart of a registering operation and a master-slave changing operation of the wireless communication apparatus according to this invention.

FIG. 3 is a flowchart of the connection operation from a mobile terminal having a master-slave changing operation in the wireless communication apparatus according to this invention.

FIG. 4 is a flowchart of the connection operation from a mobile terminal not having a master-slave changing operation in the wireless communication apparatus according to this invention.

FIG. 5 is a block diagram of a conventional wireless communication apparatus.

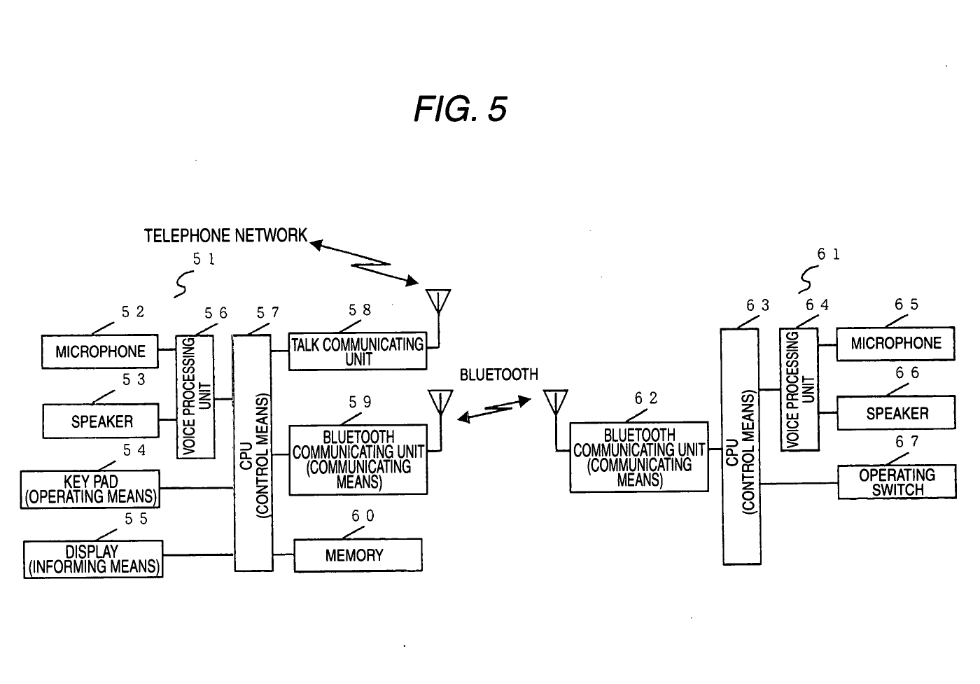

### DETAILED DESCRIPTION OF THE PREFERRED EMBODIMENTS

Now referring to the drawings, an explanation will be given of a wireless communication apparatus according to an embodiment of this invention and its controlling method.

### Embodiment 1

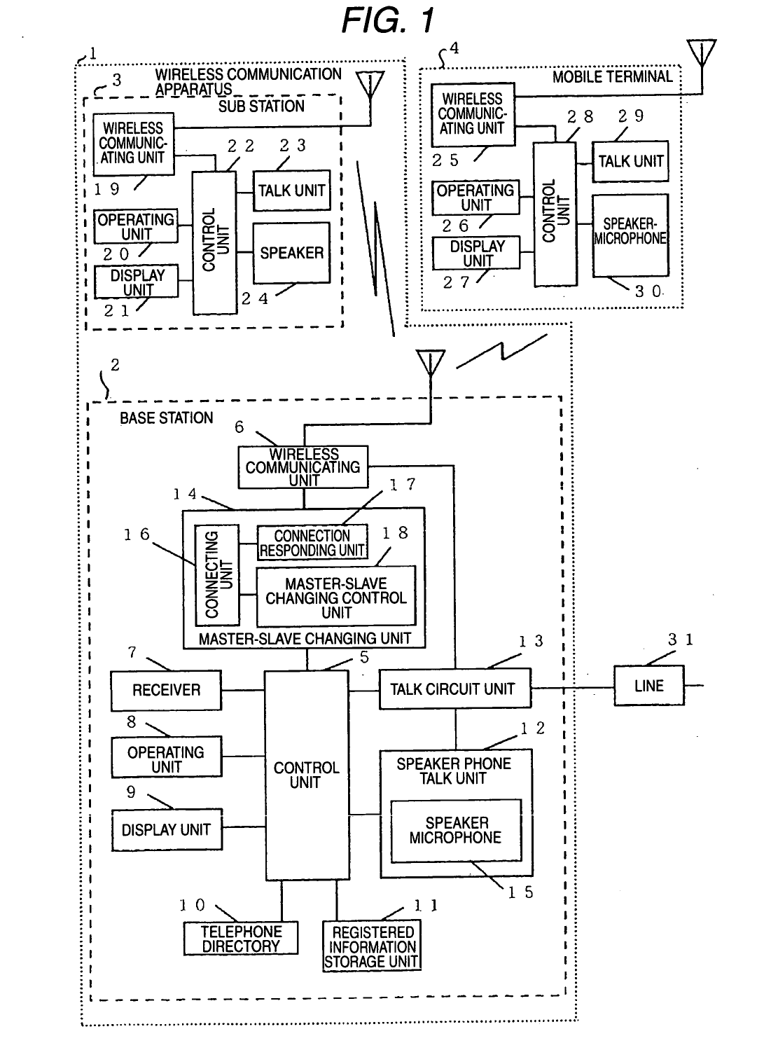

FIG. 1 is a block diagram of the wireless communication apparatus according to the first embodiment of this invention.

In FIG. 1, a wireless communication apparatus 1 according to this invention is composed of a base station 2 connected to a line 31 and a sub station 3 registered in the base station 2 and permitting duplex voice communication, which can execute duplex voice communication with a mobile terminal 4.

The base station 2 includes a wireless communicating unit 6 for making duplex voice communication with the sub station 3 and mobile terminal 4; a talk circuit unit 13 for making talk (outside talk) with the PSTN (Public Switched Telephone Network) through the line 31; a speaker phone talk unit 12 inclusive of a speaker-microphone 15 for making speaker phone talk; an operating unit 8 for making an operation such as dialing to communicate with the PTSN; a display unit 9 composed of e.g. LCD for displaying a telephone number dialed or the corresponding party name and a party telephone number or the corresponding name at the time of alert; a telephone directory 10 for previously registering a telephone number(s) and name(s); a registered information storage unit 11 for storing the information when the sub station 3 and mobile terminal 4 have been registered in the base station 2; and a master-slave changing unit 14 for changing either operation mode of the master mode and slave mode in wireless communication with the mobile terminal 4. The master-slave changing unit 14 includes a connecting unit 16 through which the base station 2 makes a connection request of wireless communication with the mobile terminal 4, a connection responding unit 17 which if the mobile terminal 4 has been registered in the base station 2, unconditionally responds permission of the connection request to the mobile terminal 4 or otherwise if not registered, responds permission of the connection request according to whether or not the connection request from the mobile terminal 4 makes a request of the master-slave change, and a master-slave changing control unit 18 for controlling the designation of the master-slave change to the mobile terminal 4. The base station 2 further includes a control unit 5 composed of CPU, RAM or ROM for controlling the entire base station 2; and a receiver 7 for making talk.

The sub station 3 includes a wireless communicating unit 19 for making duplex voice communication with the base station 2; a talk unit 23 for making intercom with the base station 2 and making talk with the PSTN; an operating unit 20 for making an operation such as dialing for talk; a display unit 21 composed of e.g. LCD for displaying a telephone number dialed or the corresponding party name and a party telephone number or the corresponding name at the time of alert; a speaker for outputting voice such as ringer tone or hold tone transmitted from the base station 2; and a control unit 22 composed of CPU, RAM or ROM for controlling the entire sub station 3.

The sub station 3 includes a wireless communicating unit 25 for making duplex voice communication with the base station 2; a talk unit 29 for making talk (external talk) with an external mobile network; an operating unit 26 for making an operation such as dialing for talk; a display unit 27 composed of e.g. LCD for displaying a telephone number dialed or the corresponding party name and a party telephone number or the corresponding name at the time of alert; a speaker-microphone 30 for making talk; and a control unit 28 composed of CPU, RAM or ROM for controlling the entire mobile terminal 4.

An explanation will be given of the operation of the wireless communication apparatus composed as described above.

Where plural wireless terminals make wireless communication with one another, there are standards of giving the concepts of “master” and “slave”. Specifically, in these standards, for example, the wireless terminal having attempted connection (link of the wire communication) with another wireless terminal serves as the master whereas the wireless terminal subjected to the attempt of connection serves as the slave. One of these standards is the Bluetooth communication standard. This invention is applicable to the Bluetooth communication standard.

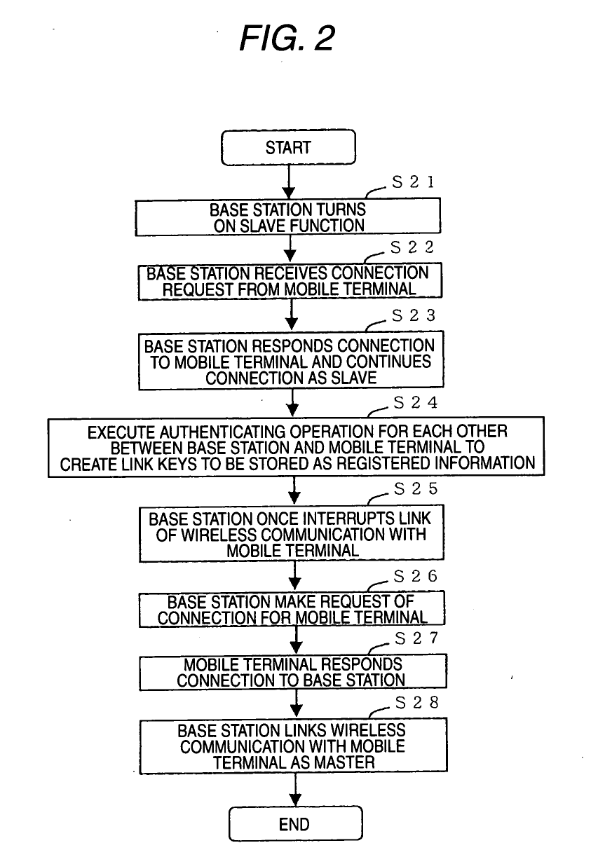

FIG. 2 is a flowchart showing the registering operation and the master-slave changing operation in the wireless communication apparatus according to the first embodiment of this invention.

First, in order that the base station 2 and the mobile terminal 4 make wireless communication with each other, the registering operation is required. If the registering operation has been completed, the subsequent connection does not require the operation such as inputting a PIN code.

The registering operation will be executed as follows. First, the master-slave change control unit 18 of the base station 2 turns on the slave function (step S21). Next, if the base station 2 receives the connection request from the mobile terminal 4 (step S22), the connection responding unit 17 of the base station 2 responds the connection to the mobile terminal 4 so that the connection is continued between the mobile terminal 4 in the master mode and the base station in the slave mode according to the Bluetooth communication standard (step S23). By inputting the PIN code in order to perform the authentication for each other between the base station 2 and mobile terminal 4, the wireless communicating unit 6 executes the authenticating operation to create a link key. Thus, the control unit 5 stores the registered information such as the link key in the registered information storage unit 11 (step S24).

After the registering has been completed in the registered information storage unit 11 of the base station 2, the base station 2 once disconnects the link of wireless communication with the mobile terminal 4 in order to make the master-slave change (step S25). This time, the base station 2 makes a request of connection for the mobile terminal 4 (step S26).

The mobile terminal 4 responds the connection to connection request from the base station 2 (step S27). Thus, the wireless communication is linked between the base station 2 in the master mode and the mobile terminal 4 in the slave mode (step S28), thereby realizing the state permitting voice communication.

Next, an explanation will be given of the connection operation in the state where the mobile terminal 4 has been already registered in the base station 2 and in both cases where the mobile terminal 4 has the master-slave changing function and does not have it.

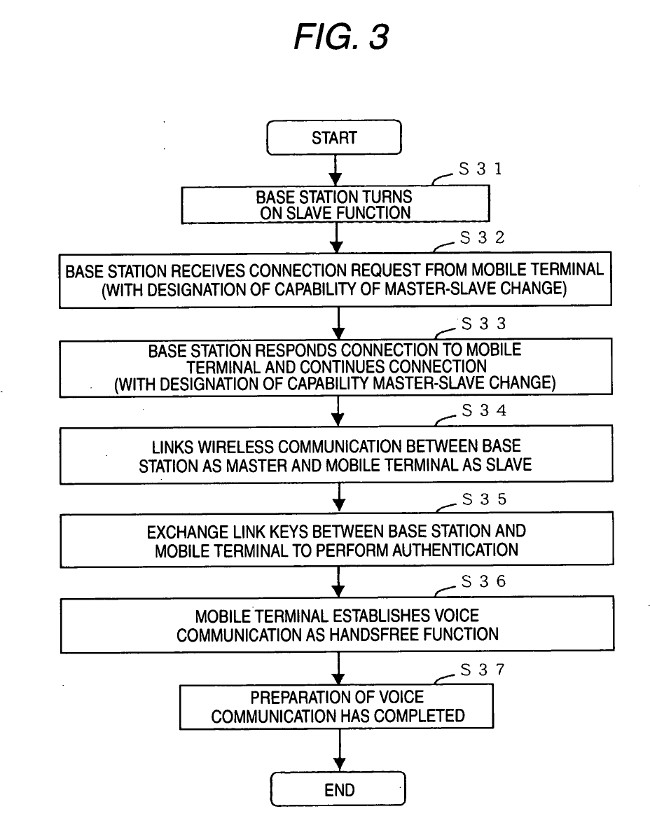

FIG. 3 is a flowchart showing the connection operation from the mobile terminal having the master-slave changing function in the wireless communication apparatus according to the first embodiment.

First, the master-slave control unit 18 of the base station 2 turns off the slave function (step S31). When the wireless communicating unit 6 of the base station 2 receives the connection request with designation of capability of the master-slave change from the mobile terminal 4 having the master-slave changing function (step S32), because the mobile terminal 4 has been already registered, the connection responding unit 17 of the base station 2 unconditionally receives the connection request from the mobile terminal 4 and the master-slave changing control unit 18 of the base station 2 controls the designation of the request of the master-slave change because the mobile terminal 4 has the master-slave changing function. Thus, the base station 2 responds the connection with this designation to the mobile terminal 4 (step S33).

The mobile terminal 4 receives the designation of the request of the master-slave change so that the wireless communication is linked between the base station 2 in the master mode and the mobile terminal 4 in the slave mode.

If the wireless communication has been linked in step S34, in order to perform the authentication for each other between the base station 2 and the mobile terminal 4, the wireless communicating unit 6 executes the authenticating operation of automatically exchanging link keys between the base station 2 and the mobile station 4 (step S35). Like where a car kit is connected for making handsfree talk with the mobile terminal 4, the mobile terminal 4 establishes the audio communication function according to the requirement of handsfree profile (step S36). Thus, the preparation of audio communication is completed (step S37).

Incidentally, in step S36, although the handsfree function is established for the connection between the mobile terminal 4 and the car kit, in the mobile terminal 4 equipped with the Bluetooth communication standard, the connection with a head set terminal can be adopted in order to establish the audio communication function. For the connection with the head set terminal, it is made according to the head set profile requirement.

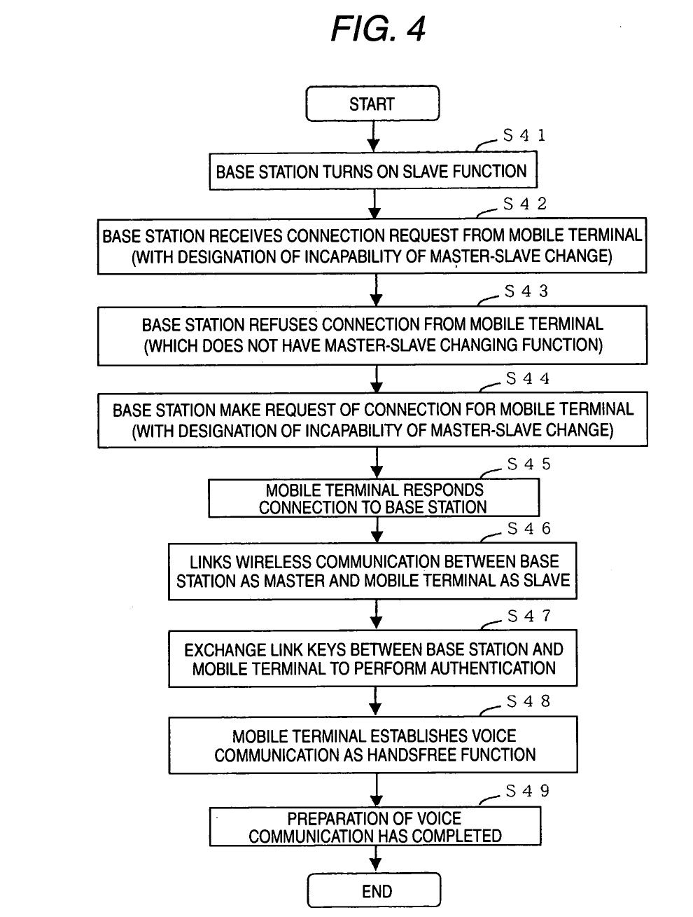

FIG. 4 is a flowchart showing the connection operation from the mobile terminal not having the master-slave changing function in the wireless communication apparatus according to the first embodiment.

First, the master-slave control unit 18 of the base station 2 turns off the slave function (step S41). When the wireless communicating unit 6 of the base station 2 receives the connection request with designation of incapability of the master-slave change from the mobile terminal 4 not having the master-slave changing function (step S42), the connection responding unit 17 of the base station 2 refuses the connection because the mobile terminal 4 does not have the master-slave changing function (step S43).

If the connection responding unit 17 of the base station 2 refuses the connection in step S43, the master-slave changing control unit 18 of the base station 2 sets incapability of the master-slave change and makes a request of connection from the base station 2 to the mobile terminal 4 (step S44). In response to this connection request, the mobile terminal 4 responds connection to the base station 2 (step S45). Thus, the wireless communication is linked between the base station 2 in the master mode and the mobile terminal 4 in the slave mode.

If the wireless communication has been linked in step S46, in order to perform the authentication for each other between the base station 2 and the mobile terminal 4, the wireless communicating unit 6 executes the authenticating operation of automatically exchanging link keys between the base station 2 and the mobile station 4 (step S47). For example, where a car kit is connected with the mobile terminal 4, the mobile terminal 4 establishes the audio communication function according to the requirement of handsfree profile (step S48). Thus, the preparation of audio communication is completed (step S49).

As understood from the above description, the registered information storing process includes step S24 in which in order to perform the authentication for each other between the base station 2 and mobile terminal 4, the wireless communicating unit 6 executes the authenticating operation of automatically exchanging link keys and the control unit 5 stores the registered information in the registered information storage unit 11.

The master-slave changing process includes step S25 in which the base station 2 once disconnects the link of wireless communication with the mobile terminal 4 in order to make the master-slave change; step S26 in which this time, the base station 2 makes a request of connection for the mobile terminal 4; step S31 in which the master-slave control unit 18 of the base station 2 turns off the slave function; step S33 in which because the mobile terminal 4 has been already registered, the connection responding unit 17 of the base station 2 unconditionally receives the connection request from the mobile terminal 4 and the master-slave changing control unit 18 of the base station 2 controls the designation of the request of the master-slave change because the mobile terminal 4 has the master-slave changing function, and thus, the base station 2 responds the connection with this designation to the mobile terminal 4; step S41 in which the master-slave changing control unit 18 of the base station 2 turns off the slave function; step S43 in which the connection responding unit 17 of the base station 2 refuses the connection because the mobile terminal 4 does not have the master-slave changing function; and step S44 in which if the connection responding unit 17 of the base station 2 refuses the connection in step S43, the master-slave changing control unit 18 of the base station 2 sets incapability of the master-slave change.

The wireless communication process includes step S22 in which the base station 2 receives the connection request from the mobile terminal 4; step S23 in which the connection is continued between the mobile terminal 4 in the master mode and the base station in the slave mode according to the Bluetooth communication standard; step S26 in which the base station 2 makes a request of connection for the mobile terminal 4; steps S27, S45 in which the mobile terminal 4 responds the connection to connection request from the base station 2; steps S28, S34, S46 in which the wireless communication is linked between the base station 2 in the master mode and the mobile terminal 4 in the slave mode; steps S32, S42 in which the wireless communicating unit 6 of the base station 2 receives the connection request with designation of capability of the master-slave change from the mobile terminal 4 having the master-slave changing function; and steps S35, S47 in which in order to perform the authentication for each other between the base station 2 and the mobile terminal 4 the wireless communicating unit 6 executes the authenticating operation of automatically exchanging link keys.

As understood from the description hitherto made, in accordance with the first embodiment, there is provided a wireless communication apparatus 1 for executing transmission and reception of a voice signal using a wireless communication technique, composed of a sub station 3 and a base station 2 which executes wireless communication with a mobile terminal 4 in either operation mode of a master mode and a slave mode, wherein the base station 2 includes a wireless communicating unit 6 for making duplex voice communication with the sub station 3 and mobile terminal 4, a master-slave changing unit 14 for changing either operation mode of the master mode and slave mode in wireless communication with the mobile terminal 4 according to whether or not the mobile terminal 4 has a master-slave changing function, a registered information storage unit 11 for storing the registered information of the sub station 3 and the mobile terminal 4 so that the master-slave change can be automatically made regardless of whether or not the mobile terminal 4 has the master-slave changing function and the base station 2 can operate in the master mode for the sub station 2 and mobile terminal 4, thereby permitting wireless communication with plural wireless terminals serving as slaves.

Incidentally, the wireless communication apparatus 1 may register plural sub stations 3.

As described above, it is needless to say that this invention can be realized in hardware as the wireless communication apparatus. In addition, while understanding the technical idea of this invention as “steps”, this invention can be realized in software as a method for controlling a cordless telephone.

As described above, the wireless communication apparatus and its control method provide a wireless communication apparatus for executing transmission and reception of a voice signal using a wireless communication technique, composed of a sub station and a base station which executes wireless communication with a mobile terminal in either operation mode of a master mode and a slave mode, which gives advantages that the master-slave change can be automatically made regardless of whether or not the mobile terminal has the master-slave changing function and the base station can operate in the master mode for the sub station and mobile terminal, thereby permitting wireless communication with plural wireless terminals serving as slaves. Thus, this invention is useful as a means for using the wireless communication apparatus in liaison with various mobile terminals.

This application is based upon and claims the benefit of priority of Japanese Patent Application No. 2005-8809 filed on Jan. 17, 2005, the contents of which are incorporated herein by reference in its entirety.

What is claimed is:

1. A wireless communication apparatus composed of a sub station and a base station, said base station comprising:
a wireless transmission-reception unit for executing, in either one operation mode of a master mode and a slave mode, duplex wireless communication with a wireless terminal and said sub station; and
a master-slave changing unit for changing the wireless communication with said wireless terminal in either operation mode of the master mode and slave mode according to whether or not said wireless terminal has a master-slave changing function,
wherein when said base station receives a connection request signal with incapability of the master-slave changing function from said wireless terminal, said master-slave changing unit does not make a change into a slave operation and so not make connection by a master operation from said wireless terminal so that said base station transmits a connection request signal by a master operation to said wireless terminal so as to be connected to said wireless terminal.

2. A wireless communication apparatus according to claim 1, wherein when said base station receives a connection request signal with capability of the master-slave changing function, said master-slave changing unit makes a change into the slave operation so that said base station is connected with said wireless terminal by the slave operation.

3. A wireless communication apparatus according to claim 1, wherein said base station is connected with the base station by the master operation.

4. A wireless communication apparatus according to claim 1, wherein said base station further comprises a registered information storage unit for storing authentication information for executing communication with said sub station and said wireless terminal, and
wherein when the wireless terminal is registered in said base station, said master-slave changing unit makes a change into the slave operation so that said base station in the slave mode is connected to said wireless terminal to transmit the authentication information, thereby permitting communication with said wireless terminal.

5. A communicating method for a wireless communication apparatus composed of a base station and a sub station, which executes transmit and receive of a voice signal by wireless with a wireless terminal, wherein when said base station receives a connection request signal with incapability of a master-slave changing function from said wireless terminal, it refuses connection by a master operation and transmits the connection request by the master operation to said wireless terminal so as to be connected with said wireless terminal.
